(19) United States
(12) Patent Application Publication
(10) Pub. No.: US 2021/0396407 A1
(43) Pub. Date: Dec. 23, 2021

(54) WIND POWERED COOLING SYSTEM

(71) Applicant: Jagannathan BASKAR, Singapore (SG)

(72) Inventor: Jagannathan BASKAR, Singapore (SG)

(21) Appl. No.: 17/289,828

(22) PCT Filed: Oct. 30, 2018
(86) PCT No.: PCT/SG2018/050545

§ 371 Date: Apr. 29, 2021

(30) Foreign Application Priority Data
Nov. 2, 2017 (SG) 10201709030P

(51) Int. Cl. F24F 5/00; F25D 21/14; F25B 27/00; F25B 40/04; F03D 9/20; F03D 15/00

(52) U.S. Cl. CPC F24F 5/0046; F25D 21/14; F25B 27/00; F05B 2260/20; F03D 9/20; F03D 15/00; F25B 2339/046; F25B 40/04

(57) ABSTRACT

A wind powered cooling system, including a windmill including a transmission rotatably coupled to at least one vane, wherein wind moving past the vane causes the vane to rotate and transmit rotational energy to the transmission; and a cooling system including: a compressor system including a compressor mechanically coupled to the transmission, the compressor including a first member for translating rotational energy of the transmission to movement of the first member with respect to a second member so as to compress a refrigerant fluid stored therein; and an evaporator system including an evaporator in fluid communication with the compressor for expanding and evaporating compressed refrigerant fluid into cold refrigerant gas, wherein the cold refrigerant gas cools air surrounding the evaporator system by convection.

### FIELD OF THE INVENTION

The present invention relates to a wind powered cooling system. The present invention also relates to an apparatus for harnessing wind energy to cool air. The present invention also relates to a wind powered clean water generating system.

### BACKGROUND OF THE INVENTION

In countries where the temperature is hot, indoor air temperatures are often high resulting in occupants feeling uncomfortable. Thermal comfort is usually achieved when the temperature and relative humidity surrounding an occupant is within a certain range, for example 23° C. to 25° C. is ideal comfort temperature range. This range may change depending on the relative temperature outdoors and the occupant's expectation.

Operating a device to regulate the indoor temperature of a space requires some form of energy input. This energy input may become quite substantial depending on the efficiency of the cooling system and the amount of heat required to be removed from a space, for example. Cooling systems for residential use are typically powered by electricity from the grid.

There has been an increase in demand for air conditioning. This may be attributed to incomes rising around the world, especially in developing countries coupled with advances in urbanisation. Additionally, record-breaking average temperatures may have contributed to the increase in the need for air conditioning.

An issue arising from this increase in heating, ventilation and air conditioning (HVAC) systems is the energy required to power such systems is quite high. Energy used to power HVAC systems in developing countries are typically powered by fossil fuels. This results in a vast amount of carbon dioxide emissions which may contribute to global warming. For example, it was found that air conditioning accounts for 40% of power use in Mumbai, India.

Due to the vast amounts of energy required to power HVAC systems, alternative means of powering HVAC systems, for example by using renewal energy, are therefore desirable. However, current systems that are powered by renewal energy typically require higher cost compared to a traditional system to buy, install, operate and maintain the system.

Additionally, in some countries, access to clean potable water can be limited. This can result in a lack of drinking water and the inability to grow crops due to insufficient irrigation. Therefore, it is desirable to have a system which can produce potable water in an energy efficient manner which would be useful especially for developing countries.

It is generally desirable to overcome or ameliorate one or more of the above described difficulties, or to at least provide a useful alternative.

### SUMMARY OF THE INVENTION

In accordance with the present invention, there is provided a wind powered cooling system, including:
(a) a windmill including a transmission rotatably coupled to at least one vane, wherein wind moving past the vane causes the vane to rotate and transmit rotational energy to the transmission; and
(b) a cooling system including:
   (i) a compressor system including a compressor mechanically coupled to the transmission, the compressor including a first member for translating rotational energy of the transmission to movement of the first member with respect to a second member so as to compress a refrigerant fluid stored therein; and
   (ii) an evaporator system including an evaporator in fluid communication with the compressor for expanding and evaporating compressed refrigerant fluid into cold refrigerant gas,
      wherein the cold refrigerant gas cools air surrounding the evaporator system by convection.

Preferably, the system includes a frame for coupling the windmill to an elongate support structure, the support structure for elevating the windmill above a ground surface. Preferably, the system further includes a passive yaw system for orientating the windmill's vane towards the wind, including:
(a) a rotating section coupled to the frame; and
(b) a stationary section coupled to the support structure,
   wherein a yaw axis is defined by a direction of extent of the support structure, and
   wherein the rotating section is configured to rotate with the frame about the yaw axis.

Preferably, the stationary section and the rotating section are positioned along the yaw axis. Preferably, the system further including:
(a) a first conduit for transmitting compressed refrigerant fluid from the compressor to the evaporator;
(b) a second conduit for transmitting vaporized refrigerant fluid from the evaporator to the compressor,
   wherein the first conduit passes through the rotating section, the stationary section and the support structure to the evaporator, and
   wherein the second conduit passes through the support structure, the stationary section and the rotating section to the compressor.

Preferably, the first conduit and the second conduit include one or more of the following:
(a) sections which pass through the support structure that form lines that are parallel to the yaw axis; and
(b) sections between the rotating section and the compressor wherein the sections rotate with the frame with respect to the support structure about the yaw axis.

Advantageously, the passive yaw system allows parts of the system, e.g. the frame supporting the windmill and the compressor, to rotate about the yaw axis with respect to the stationary parts of the system, e.g. the support structure and evaporator.

Preferably, the passive yaw system allows rotation of the conduits associated with the rotating parts of the system so as to minimize entanglement of the conduits.

Advantageously, the system further includes a potable water reservoir for collecting water formed from condensation of water vapor that occurs around the evaporator. This provides access to clean, potable water for domestic use or agricultural use in countries where access to potable water is limited, for example.

In accordance with the present invention, there is also provided an apparatus for harnessing wind energy to cool air, including:
(a) a windmill including a transmission rotatably coupled to at least one vane, wherein wind moving past the vane causes the vane to rotate and transmit rotational energy to the transmission;
(b) a frame for coupling the windmill to an elongate support structure, the support structure for elevating the windmill above a ground surface; and
(c) a passive yaw system including:
   (i) a rotating section coupled to the frame; and
   (ii) a stationary section coupled to the support structure,
   wherein a yaw axis is defined by a direction of extent of the support structure,
   the stationary section and the rotating section are positioned along the yaw axis, and
   the rotating section is configured to rotate with the frame about the yaw axis,
      wherein the transmission is mechanically couplable to a compressor, the compressor including a first member for translating the rotational energy of the transmission to movement of the first member with respect to a second member so as to compress a refrigerant fluid stored therein, and
      the compressor being in fluid communication with an evaporator for expanding and evaporating compressed refrigerant fluid into cold refrigerant gas so as to cool air surrounding the evaporator system by convection.

In accordance with the present invention there is also provided wind powered clean water generating system, including:
(a) a windmill including a transmission rotatably coupled to at least one vane, wherein wind moving past the vane causes the vane to rotate and transmit rotational energy to the transmission;
(b) a cooling system including:
   (i) a compressor system including a compressor mechanically coupled to the transmission, the compressor including a first member for translating rotational energy of the transmission to movement of the first member with respect to a second member so as to compress a refrigerant stored therein; and
   (ii) an evaporator system including an evaporator in fluid communication with the compressor for expanding and evaporating compressed refrigerant fluid into cold refrigerant gas; and
(c) a potable water reservoir for collecting water formed from condensation of water vapor that occurs around the evaporator,
   wherein the cold refrigerant gas cools air surrounding the evaporator and condenses moisture in the air surrounding the evaporator into clean water.

### BRIEF DESCRIPTION OF THE DRAWINGS

Preferred embodiments of the invention are hereafter described, by way of non-limiting example only, with reference to the accompanying drawings, in which:

FIG. 1 is a schematic diagram of a wind powered cooling system;

FIG. 2 is a schematic diagram showing components of the system shown in FIG. 1;

FIG. 3 is a close-up schematic diagram showing components of part the system shown in FIG. 2;

FIG. 4 is a line diagram showing the interoperation between the components of the system shown in FIG. 2;

FIG. 5 is a schematic diagram showing another embodiment of the system shown in FIG. 3;

FIG. 6 is a line diagram showing the interoperation between the components of the system shown in FIG. 5; and

FIG. 7 is a close-up schematic diagram of an alternate embodiment of the system shown in FIG. 1.

### DETAILED DESCRIPTION OF EMBODIMENTS OF THE INVENTION

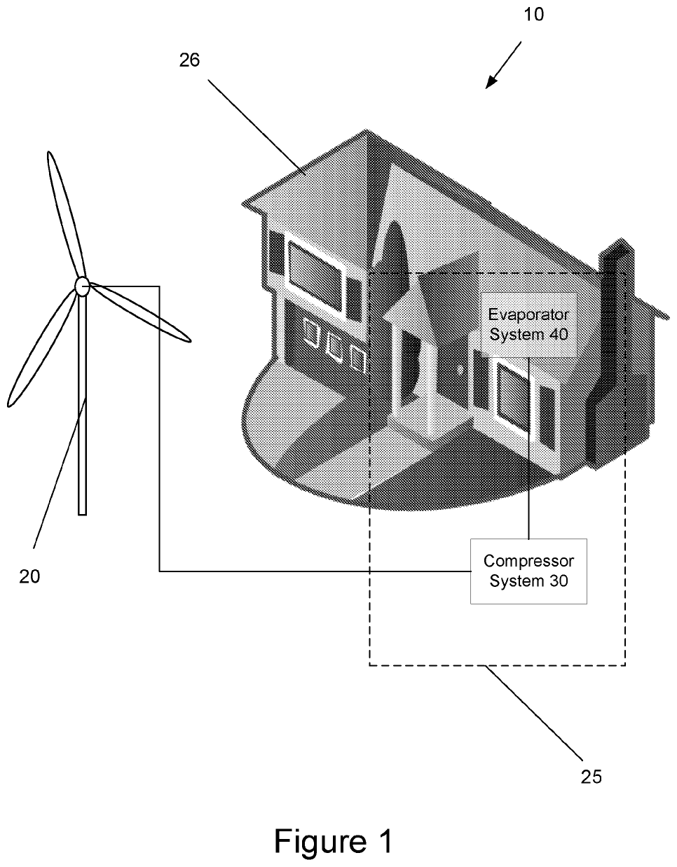

The system 10 shown in FIG. 1 is for cooling air powered by the wind's kinetic energy. The system 10 can be used to cool indoor spaces 26 or outdoor spaces such as the adjacent space around the exterior of a residential home or a beach side resort.

Additionally, when used in humid climate conditions, the system 10 can be used to produce potable water obtained from condensation of the air's moisture. For example, the potable water from system 10 can be used as an alternate source of water in developing countries with a lack of access to clean potable water. The potable water can also be used for farming in arid regions and raising crops which are not water intensive.

The system 10 can also used as an alternative to convention cooling devices like air conditioners or dehumidifiers which are powered by fossil fuels. Advantageously, the system 10 provides lower operational costs compared to conventional systems which may result in high utility bills.

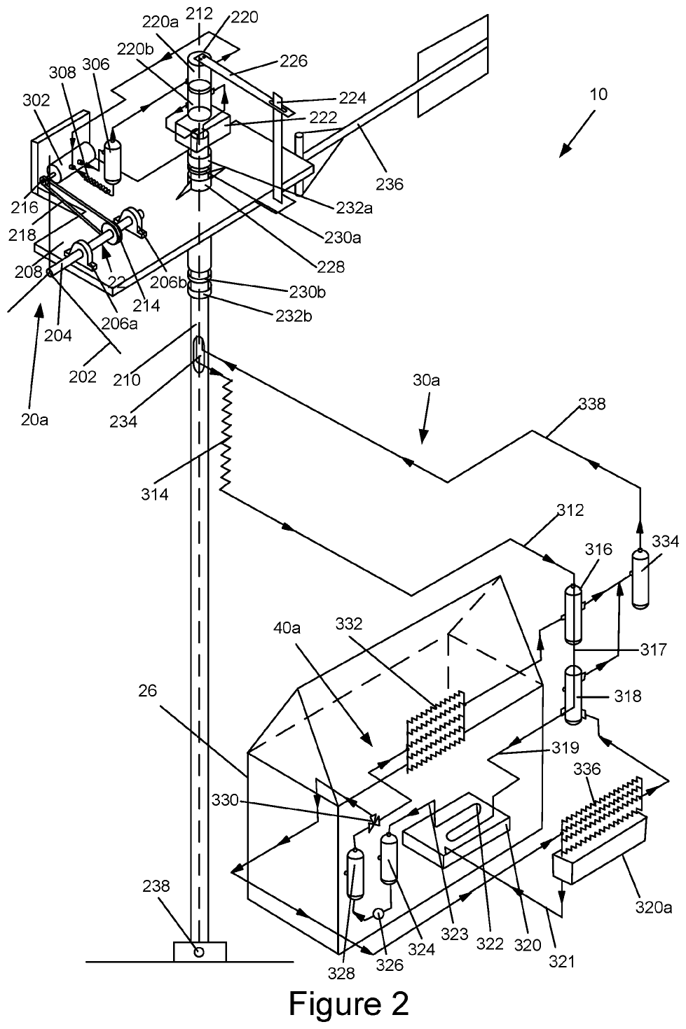

As particularly shown in FIG. 2, the system 10 includes:
(a) a windmill 20 including a transmission 22 rotatably coupled to at least one vane 202, wherein wind moving past the vane 202 causes the vane 202 to rotate and transmit rotational energy to the transmission 22;
(b) a cooling system 25, including:
   (i) an compressor system 30 including a compressor 302 mechanically coupled to the transmission 22, wherein the compressor 302 includes two members, a first member for translating rotational energy of the transmission 22 to move the first member with respect to the second member so as to compress a refrigerant fluid 338a stored therein; and
   (ii) an evaporator system 40 including an evaporator 332 in fluid communication with the compressor 302 for expanding and evaporating compressed refrigerant fluid 330a into cold refrigerant gas 332a.
      wherein the cold refrigerant gas cools the air by convection around the evaporator.

Of course, the system 10 can be used to cool either indoor or outdoor spaces. For ease of description, the system 10 is hereinafter described with reference to the evaporator system 40 being placed in an enclosed space such as a living area of a residential home.

Additionally, the system 10 can be scaled up to remove more heat if required to include multiple windmills.

The cold refrigerant gas 330a cools the air in the indoor space 26 around the evaporator 332. Advantageously, the system 10 provides a cooling system powered solely by the wind's kinetic energy which reduces the reliance on energy powered by fossil fuels.

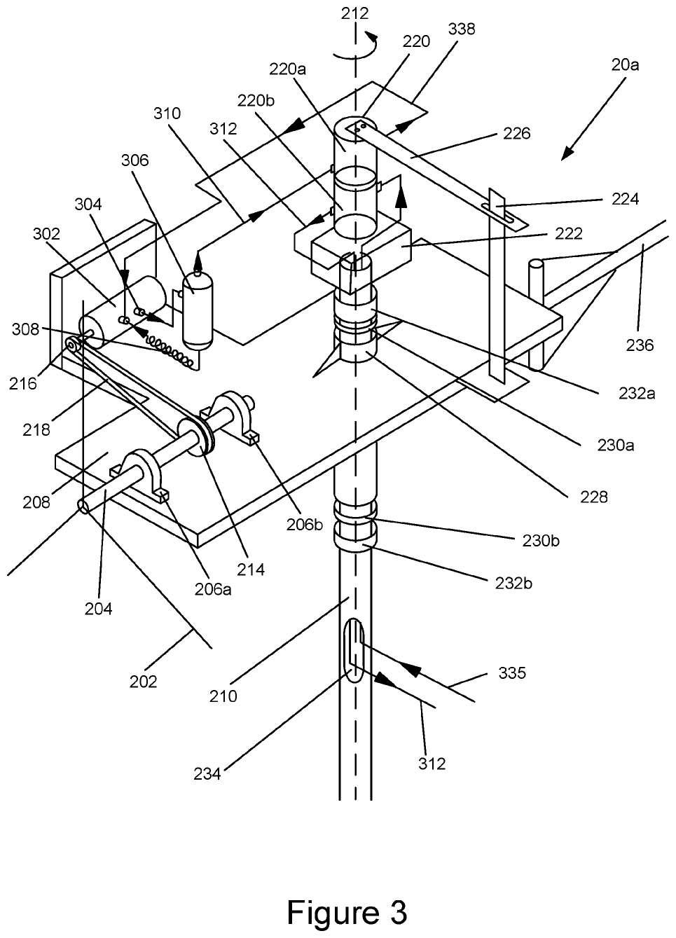

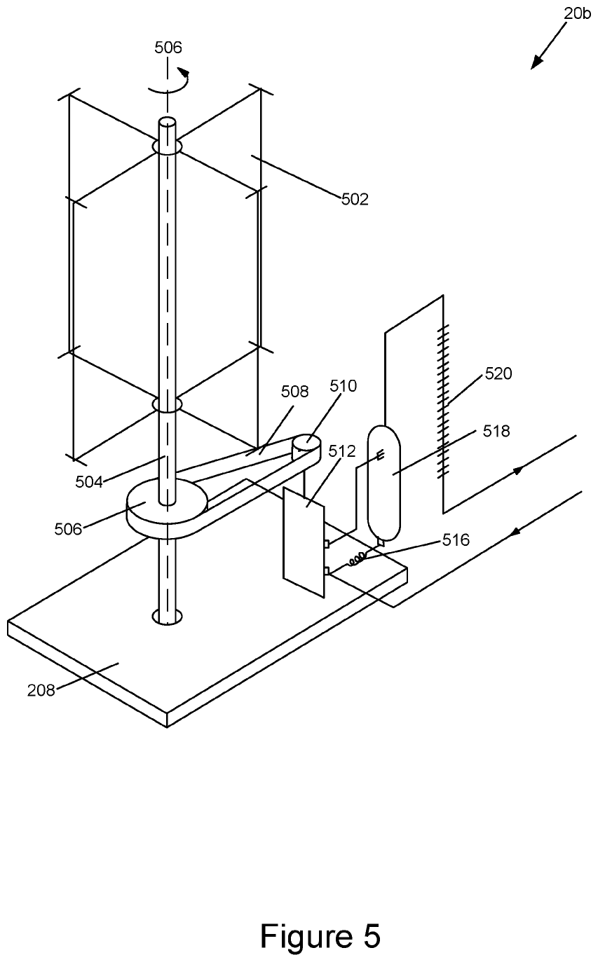

The windmill 20 in some examples is embodied by a Horizontal Axis Wind Turbine (HAWT) 20a as particularly shown in FIGS. 2 and 3 or a Vertical Axis Wind Turbine (VAWT) 20b as shown in FIG. 5. Preferably, HAWT 20a includes a swivel 220 and a tail 236 which directs the windmill 20 to the optimum position for capturing the wind's energy. In contrast with HAWT 20a, the VAWT 20b system does not require a swivel 220 and tail 236 and as such is less expensive to implement. However, the VAWT 20b system is less mechanically efficient in converting wind energy to mechanical energy compared to the HAWT 20a.

The cooling system 25 is powered entirely by windmill 20. In operation, compressed refrigerant fluid 330a expands and evaporates in evaporator 332 which lowers the air temperature adjacent to the evaporator. The refrigerant is then directed back to the compressor 302 which completes the refrigeration cycle. A three way valve 330 positioned upstream of evaporator 330 can be controlled to divert the compressed refrigerant fluid 330a to a second evaporator 336 positioned far enough from indoor space 26 that the refrigerant does not affect the temperature of indoor space 26. This ensure that's the indoor space 26 is not cooled beyond a comfortable level for occupants or during months where the outdoor air is cool such as during winter.

### Windmill 20

As particularly shown in FIGS. 2 and 3, the windmill 20 is a HAWT 20a including one or more vanes such as a plurality of rotor blades 202 which are supported on shaft 204. The rotor blades 202 are configured to rotate, for example when the wind is blowing, about an axis defined by the shaft 204. The rotor blades 202 are rotatably coupled to a transmission 22. The shaft 204 is coupled to a frame 208 by two bearings 206a, 206b, for example.

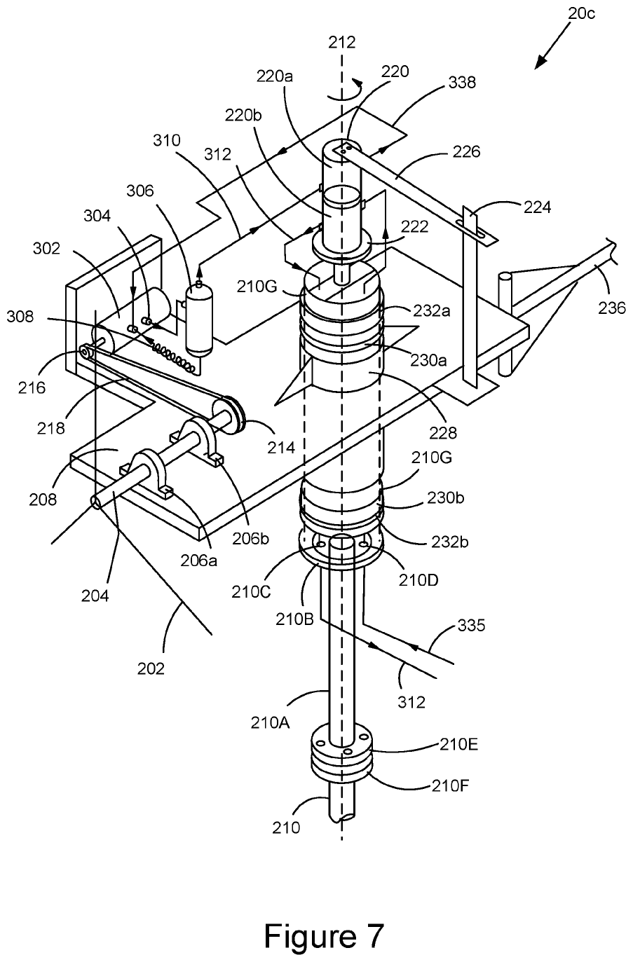

The transmission 22 includes a driver pulley 214 is mounted on the shaft 204 and drives a driven pulley 216 through a belt 218. In some embodiments, the driver pulley 214 is positioned between the bearings 206a and 206b as particularly shown in FIGS. 2 and 3. In other embodiments, the driver pulley 214 is positioned at either sides of the bearing 206a or 206b. For example, as particularly shown in FIG. 7, the driver pulley 214 is positioned at the side of bearing 206b. The driven pulley 216 is mounted on a shaft mounted on a compressor 302. Preferably, there is reduction in size ratio from driver pulley 214 to driven pulley 216. The ratio of pulley size reduction is depending upon the maximum speed limit of the compressor 302 is required to run and starting torque limitations. Therefore, the wind's kinetic energy is converted to mechanical energy to rotate the shaft on the compressor 302.

A frame 208 for coupling the windmill 20 to an elongate support structure for elevating the windmill 20 above a ground surface is provided. Preferably, the frame 208 is made of metal. Of course the frame 208 in some examples is made of any rigid material capable of supporting the weight of the windmill 20 and withstand external weather conditions such as the sun's radiant heat, high wind forces and heavy rain.

The frame 208 is configured to rotate about a longitudinal axis defined by yaw axis 212 as shown in FIG. 2. In this embodiment, the yaw axis 212 is defined by the centre line of a support structure such as pole tower pipe 210 which is mounted on hinged pin 238. Preferably, hinged pin 238 is configured to tilt pole pipe 210 down during any predicted extreme weather condition such as a cyclonic storm or maintenance works or for raising up during installation.

The rotation of the frame 208 in some examples is caused by wind blowing in the direction of tail 236. The tail is preferably mounted on the rear of the windmill frame 208. The tail 236 is provided with furling mechanism. The weight of the tail 236 is adjusted such that the furling mechanism will turn the wind mill away from wind direction once the compressor 302 maximum speed is attained. This is to protect the compressor 302 and wind mill 20 from excessive wind speeds which may damage it.

To ensure that the refrigerant tubing does not get intertwined due to the rotation of the frame, a passive yaw system including a swivel (also known as a rotary union) 220 is used. The swivel 220 as shown in FIG. 3 includes a rotating part 220a (or rotating section) and a stationary part 220b (or stationary section). The swivel 220 is held in place on top of the pole pipe 210 by hallow small frame 222. The small frame is coupled to the top end of the tower pipe 210 by a bolt, for example.

The rotating part 220a rotates with the frame 208 about the yaw axis 212 whereas the stationary part 220b is bolted or threaded to the small frame 222. The rotating part 220a and stationary part 220b are positioned along the yaw axis 212. The rotating part 220a is connected to the frame 208 by a welded flat bar 224 and through insertion into the slot hole of flat bar 226. One end of the flat bar 226 is bolted to the rotating part 220a. Thus whenever the wind mill rotates on yaw axis 212 according to the wind direction the rotating part 220a of the swivel 220 will keep track with the direction of the wind.

The 208 is welded to the pipe 228 and whole frame 208 rotates around the pole tower pipe 210 about the yaw axis 212 keeping track according to the wind direction. To ease the rotation of the wind mill on yaw axis 212 around the pole tower pipe 210, the frame is held between two bearings 230a and 230b. Preferably, grease is applied in between contacting of metal pipes 228 and 210. The frame 208 is coupled to the tower pipe 210 by two locking collar 232a, 232b. The locking collars 232a, 232b are held in place by through drilled SS bolt and nuts, for example. Advantageously, the frame is mounted on the tower pipe 210 and is elevated from the ground for capturing high speed winds.

An alternative embodiment of the windmill 20 is shown in FIG. 5 as the VAWT 20b. Unlike the HAWT 20a, the VAWT 20b has rotor blades 502 which are applied on a vertical axis. In this system with VAWT 20b, the blades 502 are mounted on a shaft 504 which defines a yaw axis 506. The blades are configured to about the axis 506 which results in a rotation of the shaft 504. A driver pulley 506 is mounted on the shaft 504 drives a driven pulley 510 through a belt 508. Preferably, there is a reduction in size ratio from driver pulley 506 to driven pulley 510. The ratio of the pulley's size reduction is decided based on the maximum speed limit of the compressor 512 or starting torque limitations. Therefore, the wind's kinetic energy is converted to mechanical energy to rotate the shaft on the compressor 512.

### Cooling Unit 25

The compressor 302 powered by the windmill 20 is preferably an open type compressor which has a low starting torque, for example a scroll type compressor. Preferably, the compressor 302 is capable of handling liquids as the compressor is being exposed to ambient atmosphere. Some condensation of the refrigerant gas to liquid is expected due to exposure to external weather conditions such as rain.

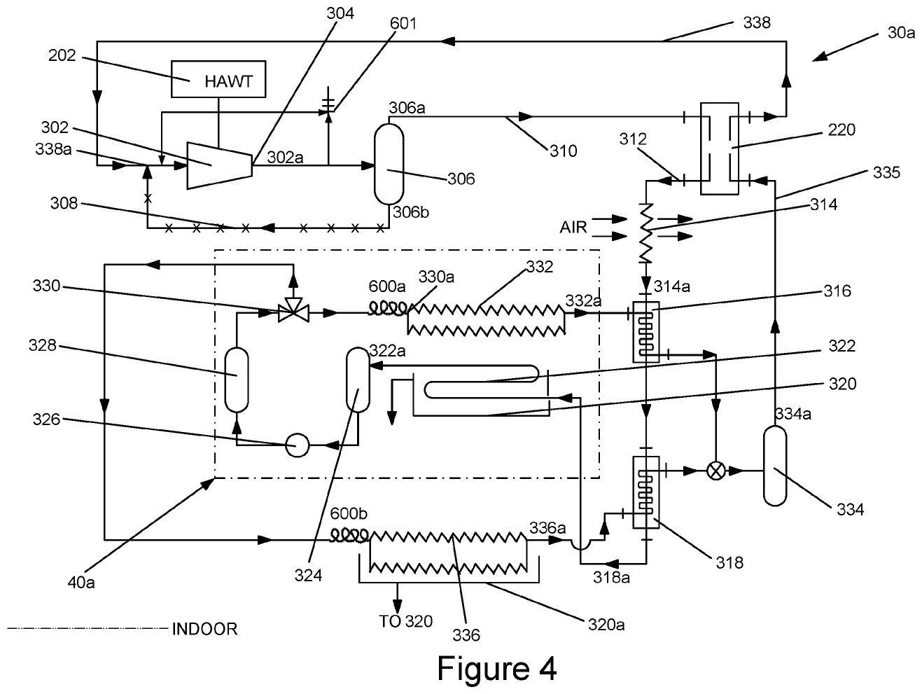

The rotation of the shaft of compressor 302 shaft at high speed, compresses the refrigerant gas 338a that is in closed loop refrigeration cycle of cooling unit 25 as particularly shown in FIG. 4.

The compressor discharge 302a, which exits the discharge outlet 304, is a mixture of compressed refrigerant gas 306a and compressor's lubrication oil 306b. To separate the compressor discharge 302a, it is passed through a filter 306 which separates the mixture to compressed refrigerant gas 306a and compressor's lubrication oil 306b. The lube oil 306b that is separated and collected in the filter 306 is returned back to compressor suction line by the capillary tube 308.

The compressed oil-free refrigerant gas 306a leaves the filter 306 through tube 310 and is connected to the rotating part 220a of the swivel 220. Compressed gas 306a travels through a first conduit inside the swivel 220 from the rotating part 220a and to the stationary part 220b and leaves swivel 220 through tube 312. The tube 312 is run, along the yaw axis 212, through the wind mill pole tower pipe 210 and exits out at the slot hole 234.

As particularly shown in FIGS. 2 and 4, the compressed refrigerant gas 306a exits the tower pipe 210 from the slot hole 234 via the discharge tube 312 which directs the refrigerant 306a to a finned tube exchanger 314. Advantageously, finned tube exchanger 314 is exposed to ambient air for cooling the refrigerant 306a and does not rely on a fan which in some examples is powered by grid electricity. Of course, a fan, powered by the wind for example, in some examples is provided to increase the efficiency of the heat exchanger 314. Preferably, the finned tube exchanger 314 is elevated along the pole tower pipe 210 compared to the evaporator 332, 336.

The compressed refrigerant gas 306a from the compressor 302 discharge is at higher temperature due to heat of compression and the superheat gained from the compression process. In the finned tube heat exchanger 314, the hot refrigerant gas 306a loses heat to ambient air which is usually at lower temperature resulting in a cooler refrigerant gas 314a. Preferably, the finned tube heat exchanger 314 includes a plurality of tubes which further includes a plurality of fins for increased efficiency of dissipating heat from the refrigerant gas 314a to the ambient air.

The refrigerant gas 314a exits the finned tube heat exchanger 314 and is further cooled by passing through double pipe exchangers 316, 318. The double pipe exchanger 316 includes a hot conduit and a cold conduit. The hot conduit for receiving compressed refrigerant 314a and the cold conduit for receiving the returning stream of refrigerant gas 332a from evaporator 332. The returning stream of refrigerant gas 332a being cooler than the refrigerant 314a resulting in heat from refrigerant 314a to dissipate to the returning stream of refrigerant gas 332a resulting in cooling of the refrigerant 314a. Similarly, double pipe exchanger 318 also includes a hot conduit and a cold conduit. The hot conduit for receiving compressed refrigerant 314a, after passing through heat exchanger 316, and the cold conduit for receiving the returning stream of refrigerant gas 336a from evaporator 336. The returning stream of refrigerant gas 336a being cooler than the refrigerant 314a resulting in heat from the refrigerant 314a to dissipate to the returning stream of refrigerant gas 336a resulting in cooling of the refrigerant 314a.

The cooled refrigerant gas 318a is then run through condenser tube 322 positioned within water collection tub 320. The condenser tube 322 is run in a plurality of circular coils to increase the contact time and increased surface area in the water collection tub 320. The condenser tube 322 is arranged such that they are submerged in the cool condensed water from evaporators 332, 336 that is collected the water collection tub 320.

The cooling processes in finned tube exchanger 314, double pipe exchanger 316, 318 and in the water collection tub 320 is to remove super heat of refrigerant gas 306a and to ensure that the refrigerant gas 322a is fully liquefied. The liquid refrigerant 322a that is condensed is collected in liquid receiver 324. At the outlet of the receiver is the sight glass 326 followed by a filter drier 328.

The sight glass 326 functions to provide visual as to the state of the refrigerant i.e. fully liquefied or partially liquefied. If the refrigerant is observed to be partially liquefied, the user can conclude that the cooling for condensation is insufficient and opt to take corrective actions. The filter is to remove debris within the system to prevent debris from reaching the capillary tube which may result in blocking its narrow passage way.

The drier 328 is to remove moisture in the closed loop refrigeration. At the outlet of the drier 328 is the three-way valve 330 which connects to an inlet of a capillary tube 600A. The capillary tube serves as expansion device. A capillary tube is typically a long and very narrow tube of a fixed diameter (typical diameters range from 0.6 mm to 3.0 mm and lengths vary from 1.0 m to 5.5 m). The capillary tube 600A separates the high pressure side of the condensing units to low pressure side that is the evaporator 332. Advantageously, as the liquid refrigerant flows from condenser through the narrow capillary tube 600A, its pressure is reduced by the frictional resistance of the capillary tube walls. The reduction in pressure causes liquid refrigerant to flash evaporate into a mixture of partial liquid and vapour. The capillary tube outlet is in fluid communication with the evaporator 332. In the evaporator, the refrigerant is further expanded and evaporated by extracting heat from the warm air surrounding the outside walls of the evaporator. Advantageously, the immediate layer of the air surrounding the evaporator is cooled. The indoor air 26 inside the residential building is cooled by natural convection of air flow around the evaporator tubes.

The vaporised gas 332a exits the evaporator 332 and flows through the double pipe heat exchanger 316 where it cools down the hot refrigerant 314a as the vaporised gas 332a is expected to be cooler than the hot refrigerant 314a. The vaporised gas 332a then exits the heat exchanger 316 and enters a gas receiver 334.

During a normal cooling cycle, whereby the space to be cooled such as an indoor living area is warmer than the desired temperature, the three-way valve 330 is directed to evaporator 332. However, if the temperature in the space is below the desired temperature, i.e. too cold, the three-way valve 330 can be directed to evaporator 336 which is located outside further away from the space to be cooled, e.g. outside the building or in an unenclosed area to prevent overcooling of the space. At the inlet of the evaporator 336 is a capillary tube 600B which reduces the high pressure of refrigerant to lower pressure and temperature in a manner similar to capillary tube 600A as described above.

The three-way valve 330 is operated manually by the person occupying the indoor space 26 allowing the person to control the comfort level of the space according to his or her preference. In another embodiment, the system is further improved by providing a three-way valve 330 that is controlled automatically by sensing the indoor air temperature and determining if the temperature is within a certain lower range indicating that the space is too cold and in response to this, directing the refrigerant to evaporator 336 instead of evaporator 332.

The liquid refrigerant exiting the three way valve 330 flows into evaporator 336 resulting in vaporised gas 336a. The vaporised gas 336a then exits the evaporator 336 and flows through the double pipe heat exchanger 318 where it cools down the hot refrigerant 314a as the vaporised gas 336a is expected to be cooler than the hot refrigerant 314a. The vaporised gas 336a then exits the heat exchanger 318 and enters a gas receiver 334.

Depending on the position of the 3 way valve 330, whether its directed towards evaporator 332 or 336, if the air within the space adjacent to the evaporators 332 or 336 is humid, sustained running of the compressor 302 may result in condensation around the evaporator tubes 332 or 336. Sustained operation of the compressor 302 may also result in a frost of ice forming around the evaporator tubes 332 or 336. The condensation and/or frost may result in moisture dripping from the evaporators 332 or 336. Water collection tub 320 is positioned below evaporator 332 for collecting moisture from evaporator 332. Preferably water collector tub 320a shall be installed at a slightly higher elevation than water collector tub 320 so that the water collected in water collector tub 320a is drained naturally by gravity to water tub 320.

Preferably, the moisture is collected in a water collection tub 320 and the collected moisture in some examples is used as a potable water source. The collected moisture in water collection tub 320 is also used to cool refrigerant 318a which flows through tubes condenser 322 from heat exchangers 316 and 318 as described in the preceding section.

The gas 334a from the gas receiver 334 flows through a second conduit wherein it exits through tube 335 passes through slot hole 234 and runs along the yaw axis 212 within the pole tower pipe 210. It exits the pole tower pipe and connects to the stationary part 220b of the swivel 220. The gas 334a then travels within the swivel 220 and exits out of the rotating part 220a of swivel 220 and connects to suction inlet of compressor 302 through tube 338 completing the full closed loop refrigerant system.

Tube sections 317, 319, 323 leading to the evaporators 332, 336 and the two double pipe exchangers 316, 318, three-way valve 330, water tub 320, 320a shall be cold insulated to prevent cold loss. The discharge side of compressor 302 e.g. discharge outlets, receiver 306, tube 308, tube 310, and swivel 220 are preferably insulated to prevent heat loss. Heat loss insulation may minimize the likelihood of liquefaction of refrigerant for instances such as a sudden drop in ambient temperature conditions like rain. For example, if the compressed refrigerant 306a liquefies at the filter 306, the refrigerant will return back to the compressor with the lube oil 306b by the capillary tube 308. Preferably, the compressor is partially insulated on the discharge end. Full insulation of the compressor may cause it to over heat during normal operation and may cause the compressor to seize up.

An alternative embodiment, system 20c as particularly shown in FIG. 7 which is a variation on system 20a as shown in FIG. 3, of the running of the conduits 312 and 335 is proposed for ease of running the conduits and maintenance works on the system. In this design, the pole pipe 210 is coupled to flange 210F, for example by a weld joint, which is further coupled to another flange 210E, for example by means of a bolt. The whole top section of the wind mill can be dismantled from 210 by removing the coupling, e.g. bolts, at the flanges 210E and 210F. The flange 210E is coupled, for example by means of a weld joint, to another smaller length of tower pipe 210A and to flat plate 210B. The flat plate 210B is coupled, for example by means of a weld joint, to another larger diameter pipe 210G. In some embodiments, the flat plate 210B between the annulus space of 210A and 210G includes channels 210C and 210D, which in some examples is formed by means of a drill. The pipe 228 in this arrangement has a larger dimeter than 210G. The frame 208 is welded to pipe 228 and the whole frame 208 is rotatable around the tower pipe 210G about the yaw axis 212 for keeping track according to wind direction. The functions of bearings for ease of rotation of the frame about the yaw axis and the two collars to keep the frame in place are as described in the preceding section. The conduits 312 and 335 enter and exit the flat plate 210B through the holes 210C and 210D. The conduits run within the pipe 210G and connect to the stationary part of the swivel.

### VAWT 20b

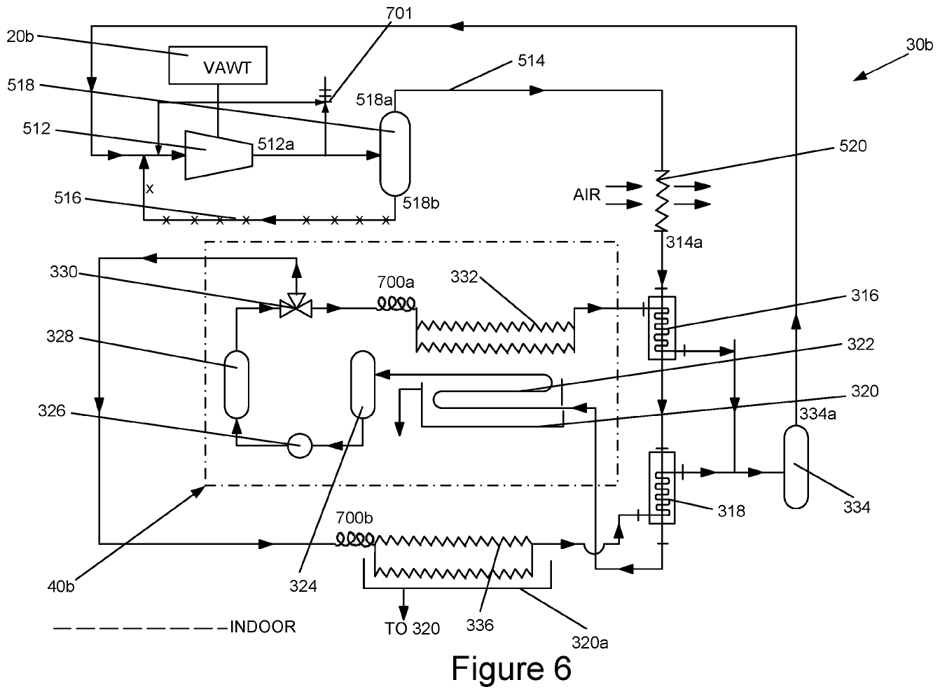

The cooling system 25 for VAWT20b includes compressor system 30b and evaporator system 40b and is similar to that described for the refrigeration cycle of compressor system 30a and evaporator system 40a for the HAWT 20a described in the preceding section. The closed loop refrigeration cycle of the VAWT 20b is particularly shown in FIG. 6. The shaft 504 rotating about the yaw axis 506 causes the driver pulley 506 and driven pulley 510 to rotate which causes the shaft of the compressor 512 to rotate. The rotation of the shaft of the compressor 512 at sufficient speed compresses the vaporised refrigerant gas 334a returning from the gas receiver 334. The compressed discharge 512a is a mixture of compressed refrigerant gas 518a and compressor's lubrication oil 518b. To separate the compressor discharge 512a, it is passed through a filter 518 which separates the mixture to compressed refrigerant gas 518a and compressor's lubrication oil 518b. The lube oil 518b that is separated and collected in the filter 518 is returned back to compressor suction line by the capillary tube 516.

The compressed refrigerant gases 518a from the filter 518 is discharged in the outlet tube 514 which is connected to finned tube heat exchanger 520. The compressed refrigerant gas 518a is at higher temperature than the ambient outdoor air and is cooled in the finned tube heat exchanger 520 which is exposed to the ambient outdoor air.

From this point in the cycle, the path of the refrigerant 314a past the heat exchanger 520 follows that of the HAWT 20a system as described in the preceding section.

### Other Embodiments

In some embodiments, the expansion device capillary tube 600A and 600B can be replaced by a Thermostatic expansion valve (TEV) upstream of the evaporator 332 is provided for more precise temperature control. The TEV regulates the amount the refrigerant 330a flow into the evaporator 332. The TEV includes a bulb which senses temperature at the evaporator 332. The TEV further includes biasing means such as a spring which in normal operation, is biased to close the valve. The TEV senses the temperature at evaporator 332 and in response to a temperature increase at evaporator 332, the valve of the TEV is further opened against the biasing means. This increases the flow of refrigerant 330a to the evaporator 332 which reduces the air temperature surrounding the evaporator 332. When the bulb of the TEV senses that the temperature at the evaporator 332 is too low, the valve of the TEV is further closed to reduce the refrigerant 330a flow to the evaporator 332.

Alternatively, the capillary tube 600A, 600B, 700A or 700B, in some examples, is substituted with an expansion device. In some embodiments, the expansion device is an orifice, hand operated valve, automatic expansion valve (constant pressure), float type expansion valve or electronic expansion valve.

In some embodiments, as particularly shown in FIG. 4, a pressure safety valve (PSV) 601 is provided immediately at outlet of compressor 304, on line 302a. The discharge of the PSV is connected to inlet line of the compressor 304. PSV is to reduce occurrence of overpressure on the compressor beyond its safety limits. In other embodiments, as particularly shown in FIG. 6, a similar PSV 701 arrangement is provided for system 30b.

Preferably, a belt tensioner is provided for belt 218 of the pulley as shown in FIG. 2 for preventing slack in the belt 218 which may set in over the time.

The compressor 302 and refrigerant gas pressure inside the system may offer high starting resistance (cogging) against the rotation of the propeller 202. In some cases, it may even stall the propeller blades from rotation. To overcome the starting resistance, a clutch mechanism on the shaft 204 can be provided. The clutch is positioned between shaft 204 and the pulley 214, for example. The clutch will preferably allow the shaft to turn freely without compressor's load for first few revolutions of the shaft. As the shaft picks up speed proportionate to the wind speed the clutch shall lock the transmission to the compressor's shaft.

Alternatively, the finned tube exchanger 314 could be fixed on frame 208 e.g. in between the swivel 220 and tail 236. In some embodiments, this position is on the winds path that is exiting from the propeller vane 202. This provides enhanced forced cooling compressed refrigerant gases.

In other embodiments, the system 10 is used along with conventional air conditioners. Preferably, the conventional air conditioner has a thermostat that has been set at a temperature of slightly higher than the desired temperature. If the system 10 cannot operate due to insufficient wind speed, the thermostat will detect that the temperature in the space 26 is higher than the set point (desired level) and will switch on the conventional air conditioner automatically. If the system 10 picks up enough kinetic energy from the wind to operate the compressors, the conventional air conditioner will detect a drop in temperature to be within the temperature set point and will shut off automatically.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge.

1. A wind powered cooling system, including:
(a) a windmill including a transmission rotatably coupled to at least one vane, wherein wind moving past the vane causes the vane to rotate and transmit rotational energy to the transmission; and
(b) a cooling system including:
(i) a compressor system including a compressor mechanically coupled to the transmission, the compressor including a first member for translating rotational energy of the transmission to movement of the first member with respect to a second member so as to compress a refrigerant fluid stored therein; and
(ii) an evaporator system including an evaporator in fluid communication with the compressor for expanding and evaporating compressed refrigerant fluid into cold refrigerant gas,
wherein the cold refrigerant gas cools air surrounding the evaporator system by convection.

2. The system claimed in claim 1, including a frame for coupling the windmill to an elongate support structure, the support structure for elevating the windmill above a ground surface.

3. The system claimed in claim 2, including a passive yaw system for orientating the windmill's vane towards the wind, including:
(a) a rotating section coupled to the frame; and
(b) a stationary section coupled to the support structure,
wherein a yaw axis is defined by a direction of extent of the support structure, and
wherein the rotating section is configured to rotate with the frame about the yaw axis.

4. The system claimed in claim 3, wherein the stationary section and the rotating section are positioned along the yaw axis.

5. The system claimed in claim 3, including:
(a) a first conduit for transmitting compressed refrigerant fluid from the compressor to the evaporator;
(b) a second conduit for transmitting vaporized refrigerant fluid from the evaporator to the compressor,
wherein the first conduit passes through the rotating section, the stationary section and the support structure to the evaporator, and
wherein the second conduit passes through the support structure, the stationary section and the rotating section to the compressor.

6. The system claimed in claim 5, wherein the first conduit and the second conduit include one or more of the following:
(a) sections which pass through the support structure that form lines that are parallel to the yaw axis; and
(b) sections between the rotating section and the compressor wherein the sections rotate with the frame with respect to the support structure about the yaw axis.

7. The system claimed in claim 2, including a tail coupled to the frame for causing the frame to rotate about the yaw axis with respect to the support structure in response to wind acting on the tail.

8. The system claimed in claim 1, wherein the evaporator includes one or more tubes for housing cold refrigerant gas so as to cool air surrounding the evaporator by convection.

9. The system claimed in claim 1, including a potable water reservoir for collecting water formed from condensation of water vapor that occurs around the evaporator.

10. The system claimed in claim 9, wherein the compressed refrigerant fluid within a section of the first conduit extends through, and is further cooled by, the water collected in the reservoir.

11. The system claimed in claim 1, including one or more heat exchangers for cooling the compressed refrigerant fluid from the compressor so as to further liquefy the refrigerant fluid.

12. The system claimed in claim 11, wherein one of the one or more heat exchangers is a finned tube heat exchanger for cooling the refrigerant fluid from the compressor by dissipating heat in the refrigerant fluid to ambient air surrounding the finned tube heat exchanger.

13. The system claimed in claim 11, wherein one of the one or more heat exchangers is a double pipe exchanger for cooling the refrigerant fluid from the compressor by dissipating heat in the refrigerant fluid to cold refrigerant gas received from the evaporator.

14. An apparatus for harnessing wind energy to cool air, including:
(a) a windmill including a transmission rotatably coupled to at least one vane, wherein wind moving past the vane causes the vane to rotate and transmit rotational energy to the transmission;
(b) a frame for coupling the windmill to an elongate support structure, the support structure for elevating the windmill above a ground surface; and
(c) a passive yaw system including:
(i) a rotating section coupled to the frame; and
(ii) a stationary section coupled to the support structure;
wherein a yaw axis is defined by a direction of extent of the support structure, the stationary section and the rotating section are positioned along the yaw axis, and
the rotating section is configured to rotate with the frame about the yaw axis,
wherein the transmission is mechanically couplable to a compressor, the compressor including a first member for translating the rotational energy of the transmission to movement of the first member with respect to a second member so as to compress a refrigerant fluid stored therein, and
the compressor being in fluid communication with an evaporator for expanding and evaporating compressed refrigerant fluid into cold refrigerant gas so as to cool air surrounding the evaporator system by convection.

15. The apparatus claimed in claim 14, including:
(a) a first conduit for transmitting compressed refrigerant fluid from the compressor to the evaporator;
(b) a second conduit for transmitting vaporized refrigerant fluid from the evaporator to the compressor,
wherein the first conduit passes through the rotating section, the stationary section and the support structure to the evaporator, and
wherein the second conduit passes through the support structure, the stationary section and the rotating section to the compressor.

16. The apparatus claimed in claim 15, wherein the first conduit and the second conduit include one or more of the following:
(a) sections which pass through the support structure that form lines that are parallel to the yaw axis; and
(b) sections between the rotating section and the compressor wherein the sections rotate with the frame with respect to the support structure about the yaw axis.

17. The apparatus claimed in claim 14, including a tail coupled to the frame for causing the frame to rotate with respect to the support structure in response to wind acting on the tail.

18. The apparatus claimed in claim 14, wherein the evaporator includes one or more tubes for housing cold refrigerant gas so as to cool air surrounding the evaporator by convection.

19. The apparatus claimed in claim 14, including a potable water reservoir for collecting water formed from condensation of water vapor that occurs around the evaporator.

20. A wind powered clean water generating system, including:
(a) a windmill including a transmission rotatably coupled to at least one vane, wherein wind moving past the vane causes the vane to rotate and transmit rotational energy to the transmission;
(b) a cooling system including:
(i) a compressor system including a compressor mechanically coupled to the transmission, the compressor including a first member for translating rotational energy of the transmission to movement of the first member with respect to a second member so as to compress a refrigerant stored therein; and
(ii) an evaporator system including an evaporator in fluid communication with the compressor for expanding and evaporating compressed refrigerant fluid into cold refrigerant gas; and
(c) a potable water reservoir for collecting water formed from condensation of water vapor that occurs around the evaporator,
wherein the cold refrigerant gas cools air surrounding the evaporator and condenses moisture in the air surrounding the evaporator into clean water.
